(19) United States
(12) Patent Application Publication
(10) Pub. No.: US 2010/0128670 A1
(43) Pub. Date: May 27, 2010

(54) Base station interference-free antenna module and WiFi base station mesh network system using the antenna module

(75) Inventors: Michael Chen, Hsin-Chu (TW); Ming-Chen Chou, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: Kuang Sheng Yun Ltd., Hsinchu City (TW)

(21) Appl. No.: 12/458,289

(22) Filed: Jul. 8, 2009

(30) Foreign Application Priority Data
Nov. 27, 2008 (TW) 097145944

(51) Int. Cl. H04W 84/02; H04W 88/08

(52) U.S. Cl. 370/328; 455/562.1

(57) ABSTRACT

A base station interference-free antenna module includes a plurality of high frequency transceivers respectively facing different directions, and an antenna controller electrically coupled to the high frequency transceivers. The antenna controller is electrically coupled to a signal processor in order to receive a signal transmitting/receiving request output by the signal processor to accordingly select a high frequency transceiver to transmit or receive a circularly polarized high frequency signal. The system includes two WiFi base stations, each having the base station interference-free antenna module and a signal processor, and the high frequency signals wirelessly transmitted between the WiFi base stations in the system are circularly polarized.

### BACKGROUND OF THE INVENTION

1. Field of the Invention

The present invention relates to a base station interference-free antenna module and a wireless fidelity (WiFi) base station mesh network system and, more particularly, to a base station interference-free antenna module capable of improving wireless transmission efficiency of a high frequency signal between two WiFi base stations and the signal to noise ratio (SNR) of wireless transmission of high frequency signals, and the system using the base station interference-free antenna module to effectively reduce the deployment density of WiFi base stations while maintaining the desired quality of service (QoS), in addition to improving the efficiency of wireless transmission of high frequency signals between two WiFi base stations.

2. Description of Related Art

In recent years, WiFi technology has been widely implemented in the wireless network systems of metropolitan areas, and people can access internet wherever by using a notebook computer or a personal digital assistant (PDA) with wireless capability, thereby gaining the goal of mobile broadband. As shown in FIG. 1, a typical WiFi base station mesh network system includes a first WiFi base station 11, a second WiFi base station 12 and a third WiFi base station 13. The distances between each two of the base stations range from 50 meters to 150 meters. The first WiFi base station 11 is electrically coupled to a remote server 15 (such as a digital switch) through a physical network line 14. The second WiFi base station 12 and the third WiFi base station 13 transmit signals received from a client-side electronic device (such as a cell phone, a notebook computer, a PDA and the like) to the first WiFi base station 11 in wireless manner (which is referred to as a cross-link procedure) and subsequently forwards the signals to the remote server 15 through the physical network line 14. Similarly, the signals are delivered in reverse direction to the first WiFi base station 11 through the physical network line 14 and subsequently transmitted in wireless manner (i.e., the cross-link procedure) to the second WiFi base station 12 or third WiFi base station 13 and finally to the cell phone, the notebook computer or the PDA covered by the second WiFi base station 12 or third WiFi base station 13.

Therefore, the transmission efficiency of signals wirelessly between two WiFi base stations in a typical WiFi base station mesh network system is quite important. In addition, buildings, moving vehicles and dirty air particles in a metropolitan area can cause poor transmission efficiency of the wireless network. Thus, the signal to noise ratio (SNR) of wireless transmission could not be improved effectively, and it is likely resulting in signal loss. In order to maintain a desired QoS, it is necessary to increase the deployment density of WiFi base stations in the typical WiFi base station mesh network system (namely, to reduce the distance between two WiFi base stations). However, it causes that the entire deployment cost of the typical WiFi base station mesh network system is largely increased (for it requires more WiFi base stations), and may also affect on the health of people around the WiFi base stations.

To overcome the aforementioned problems, in the industry, a smart antenna is proposed as a solution to replace the wireless transmission antenna of the WiFi base station. The smart antenna can only receive the high frequency signals with a specific frequency, in a specific direction, and within a specific time slot. Accordingly, other high frequency signals with different frequencies or in different directions (such as the high frequency signals reflected by the buildings or transmitted to the WiFi base station by other consumer equipments) are not received by the smart antenna, and the wireless transmission efficiency between the WiFi base stations is improved. However, the smart antenna is very expensive, and the cost could be even higher than the entire WiFi base station. Thus, for the industry, WiFi base stations with the smart antenna could not be implemented widely. Therefore, the smart antenna can only solve partial of the aforementioned problems.

Therefore, there is a need for the industry to have a base station interference-free antenna module, which can improve the efficiency and the SNR (signal to noise ration) of wirelessly transmitting high frequency signals between two WiFi base stations, and a WiFi wireless base station mesh network system, which can improve the transmission efficiency of high frequency signals between two WiFi base stations in the system and minimize the deployment density of WiFi base stations in the system under the condition of maintaining a certain level of quality of service (QoS).

### SUMMARY OF THE INVENTION

An object of the present invention is to provide a base station interference-free antenna module, which can increase the wireless transmission efficiency of high frequency signals between two WiFi base stations and also the SNR of wireless transmission of high frequency signals.

Another object of the present invention is to provide a WiFi base station mesh network system, which can increase the wireless transmission efficiency of high frequency signals between two WiFi base stations and effectively minimize the deployment density of WiFi base stations while maintaining a desired QoS.

To achieve the objects, a base station interference-free antenna module is provided, which is implemented with a signal processor in a wireless fidelity (WiFi) base station and the signal processor is applied to the high frequency signal transmission between the WiFi base station and another WiFi base station. The antenna module includes a plurality of high frequency transceivers facing different directions respectively, and an antenna controller electrically coupled to the high frequency transceivers. The antenna controller is electrically coupled to the signal processor in order to receive a signal transmitting/receiving request output by the signal processor to accordingly select a high frequency transceiver to transmit or receive a circularly polarized high frequency signal.

To achieve the objects, a WiFi base station mesh network system is provided. The system includes: a first WiFi base station having a first base station interference-free antenna module and a first signal processor, the base station interference-free antenna module having a plurality of first high frequency transceivers facing different directions respectively, and a first antenna controller electrically coupled to the first high frequency transceivers respectively. The first antenna controller is electrically coupled to the first signal processor in order to select a first high frequency transceiver based on a signal transmitting/receiving request output by the first signal processor to thereby transmit or receive a circularly polarized first high frequency signal; and a second WiFi base station having a second base station interference-free antenna module and a second signal processor, the second base station interference-free antenna module having a plurality of second high frequency transceivers facing different directions respectively, and a second antenna controller electrically coupled to the second high frequency transceivers respectively. The second antenna controller is electrically coupled to the second signal processor to select a second high frequency transceiver based on a signal transmitting/receiving request output by the second signal processor to thereby transmit or receive a circularly polarized second high frequency signal. In addition, one of the first high frequency transceivers faces the second WiFi base station, and one of the second high frequency transceivers faces the first WiFi base station.

Therefore, the high frequency signals transmitted by the high frequency transceivers of the base station interference-free antenna module in the invention have a circular polarization characteristic (such as left-hand circular polarization), and when the circularly polarized high frequency signals are reflected by an obstacle (such as a building or vehicle), its circular polarization characteristic would be changed (such as changed from left-hand circular polarization to right-hand circular polarization). Therefore, the antenna controller of the base station interference-free antenna module of a second WiFi base station can deliver only the high frequency signal with a specific circular polarization (such as left-hand circular polarization) to the signal processor by the internal circular polarization filtering property. In this case, even if the reflected high frequency signals are received by the second high frequency transceivers of the second WiFi base station, they cannot enter the signal processor due to the right-hand circular polarization characteristic. Namely, the noises produced by the reflected high frequency signal or signals are effectively suppressed, so the SNR of wirelessly transmitting the high frequency signals can be raised and the wireless transmission efficiency of high frequency signals between two WiFi base stations is raised.

Similarly, since each high frequency transceiver of the antenna module respectively in the two WiFi base stations of the WiFi base station mesh network system can transmit or receive circularly polarized high frequency signals, the other WiFi base station can easily receive the high frequency signal with the same circular polarization when one WiFi base station transmits the high frequency signal with a specific circular polarization, and the SNR and the transmission efficiency are accordingly raised when wirelessly transmitting the high frequency signals. Therefore, the WiFi base station mesh network system can increase the distance between the WiFi base stations (i.e., reduce the deployment density of the WiFi base stations), while maintaining the desired QoS.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of a typical WiFi base station mesh network system;

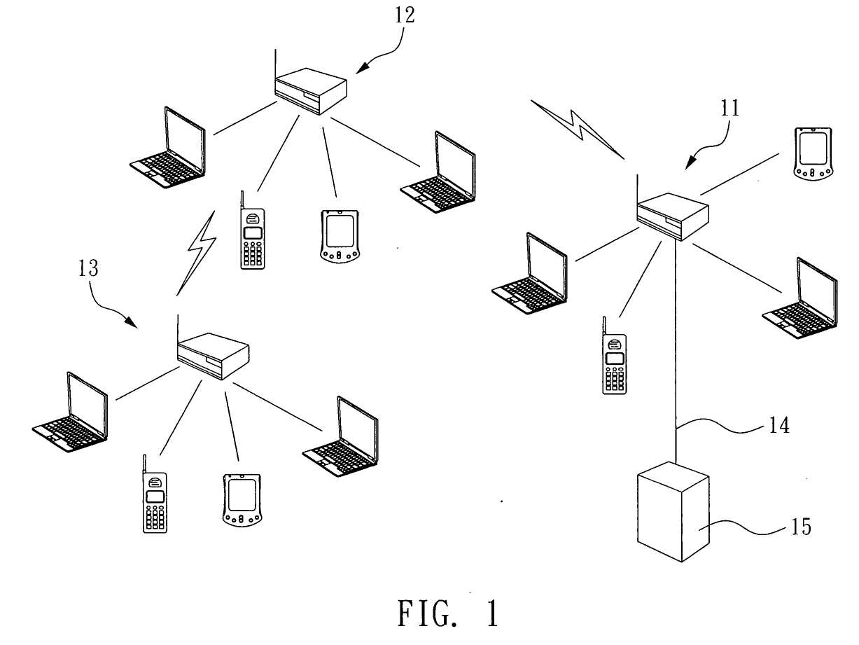

FIG. 2 is a schematic view of a base station interference-free antenna module according to an embodiment of the invention;

FIG. 3 is a schematic view of a WiFi base station mesh network system according to an embodiment of the invention;

FIG. 4 is a schematic view of a first WiFi base station of a WiFi base station mesh network system according to an embodiment of the invention; and

FIG. 5 is a schematic view of a second WiFi base station of a WiFi base station mesh network system according to an embodiment of the invention.

### DETAILED DESCRIPTION OF THE PREFERRED EMBODIMENT

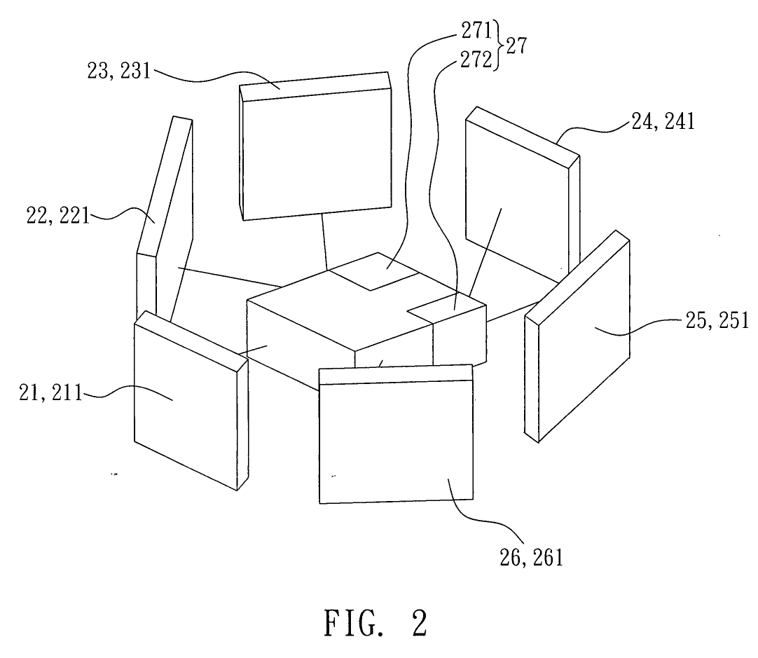

FIG. 2 is a schematic view of a base station interference-free antenna module according to an embodiment of the invention. As shown in FIG. 2, the module includes a plurality of high frequency transceivers 21 to 26 and an antenna controller 27. The high frequency transceivers 21 to 26 face different directions respectively, and the antenna controller 27 is electrically coupled to the high frequency transceivers 21 to 26 respectively. In addition, the base station interference-free antenna module is implemented in a wireless fidelity (WiFi) base station (shown later) and applied to a high frequency signal transmission between the WiFi base station and another WiFi base station (shown later).

The WiFi base station (shown later) with the base station interference-free antenna module has a signal processor (shown later), and the antenna controller 27 is electrically coupled to the signal processor (shown later). The antenna controller 27 is based on a signal transmitting/receiving request output by the signal processor to select one of the high frequency transceivers 21, 22, 23, 24, 25 and 26 to transmit or receive the circularly polarized high frequency signal.

The antenna module shown in FIG. 2 has one to six high frequency transceivers 21 to 26, each being a patch array antenna, and each of the high frequency transceivers 21 to 26 has a rectangle plate 211, 221, 231, 241, 251, 261. In this embodiment, the rectangle plates 211, 221, 231, 241, 251, 261 have a size of 10 cm×10 cm. The antenna controller 27 includes a circular polarization filter portion 271 to filter the high frequency signals respectively received by the high frequency transceivers 21 to 26. Thus, only the high frequency signal with a specific circular polarization (such as left-hand circular polarization) can be obtained and delivered to the signal processor (shown later) of the WiFi base station (shown later).

In this embodiment, the antenna controller 27 includes an electronic scan switch circuit board 272 to rapidly switch and select one of the high frequency transceivers 21, 22, 23, 24, 25 and 26 electronically based on the signal transmitting/receiving request output by the signal processor to thereby transmit or receive a circularly polarized high frequency signal. In this embodiment, the frequency of the circularly polarized high frequency signals transmitted or received by the high frequency transceivers 21, 22, 23, 24, 25 and 26 is about 2.4 GHz (upon the practical needs, the actual frequency is slightly varied in a frequency range between 3.4 GHz and 3.6 GHz or between 5.6 GHz to 5.8 GHz, for example).

It is noted that the number of high frequency transceivers of the base station interference-free antenna module can be one to six, depending on the practical needs, but not limited to six as cited in this embodiment. In addition, depending on the practical needs, each of the high frequency transceivers can be a different type of antenna, which is capable of transmitting or receiving circularly polarized high frequency signals, such as a waveguide slot array antenna or a sector horn antenna, but not limited to the patch array antenna as cited in this embodiment, and all the high frequency transceivers do not need to be the same type of antenna. The high frequency signal can range between 2.3 GHz and 2.5 GHz, between 3.4 GHz and 3.6 GHz or between 5.6 GHz and 5.8 GHz, depending on the practical needs (such as in different environments), but not limited to 2.4 GHz as cited in this embodiment.

Since the circular polarization characteristic of the high frequency signals is changed when the high frequency signals are reflected by obstacles, the circular polarization characteristic can be restored to the original circular polarization (such as the left-hand circular polarization) when the high frequency signals are reflected again. In this case, although the circularly polarized high frequency signals which have been reflected twice could pass the circular polarization filter portion of the antenna controller of the base station interference-free antenna module of the second WiFi base station and be delivered to the signal processor of the second WiFi base station, the strength of the high frequency signals is decayed to a very low level after being reflected twice, and the wireless transmission of high frequency signals between the WiFi base stations would not be affected by the noises produced by the high frequency signals which have been reflected twice. Namely, for the base station interference-free antenna module in this embodiment, the SNR of wirelessly transmitting the high frequency signals is not decreased due to the high frequency signals which have been reflected twice. Therefore, the wireless transmission efficiency of high frequency signals between two WiFi base stations is raised by using the base station interference-free antenna module.

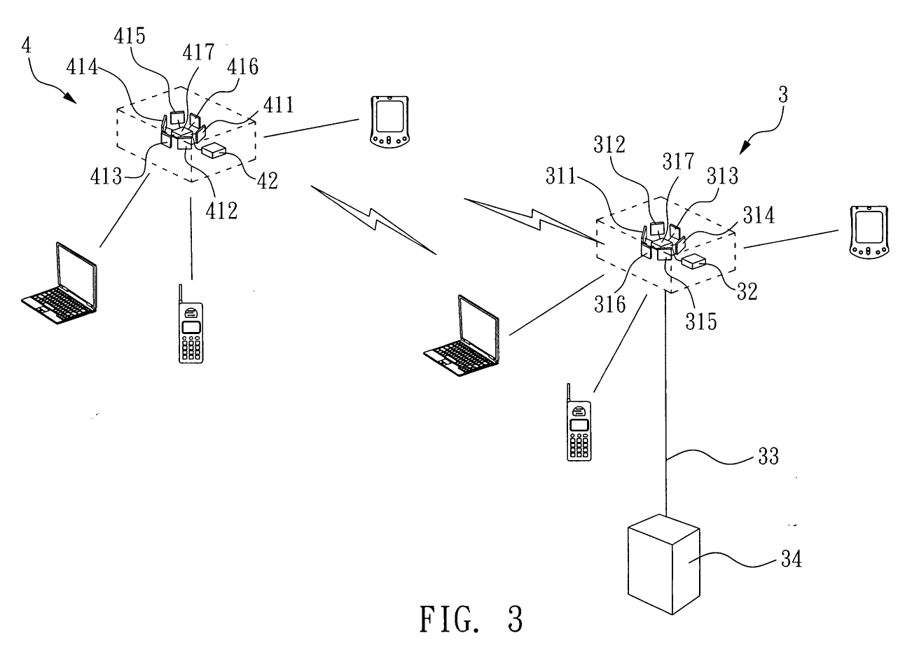

FIG. 3 is a schematic view of a WiFi base station mesh network system according to an embodiment of the invention. As shown in FIG. 3, the WiFi base station mesh network system includes a first WiFi base station 3 and a second WiFi base station 4. The distance between the WiFi base stations 3 and 4 ranges between 200 meters and 300 meters, which is far greater than that in a typical base station mesh network system (which is about between 50 meters and 150 meters).

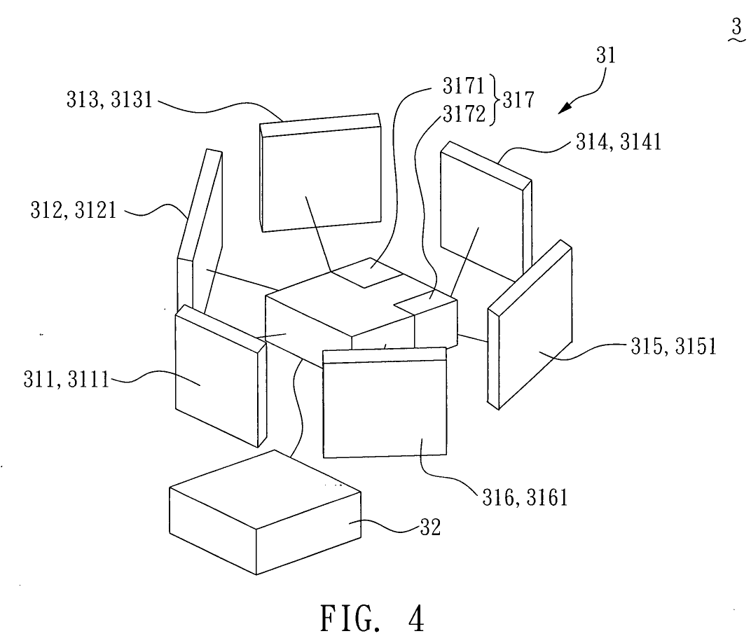

FIG. 4 is a schematic view of the first WiFi base station 3 according to an embodiment of the invention. As shown in FIG. 4, the first WiFi base station 3 includes a first base station interference-free antenna module 31 and a first signal processor 32. The first base station interference-free antenna module 31 has a plurality of first high frequency transceivers 311 to 316 and a first antenna controller 317. The first high frequency transceivers 311 to 316 face different directions respectively. The first antenna controller 317 is electrically coupled to the high frequency transceivers 311 to 316 respectively. In addition, the first antenna controller 317 is electrically coupled to the first signal processor 32 in order to select one of the first high frequency transceivers 311, 312, 313, 314, 315 and 316 based on a signal transmitting/receiving request output by the first signal processor 32 to thereby transmit or receive the circularly polarized first high frequency signal. As shown in FIG. 3, the first WiFi base station 3 is electrically coupled to a remote server 34 through a physical network line 33. In this embodiment, the physical network line 33 could be a network cable of a backbone network, and the remote server is a server located in a switch room.

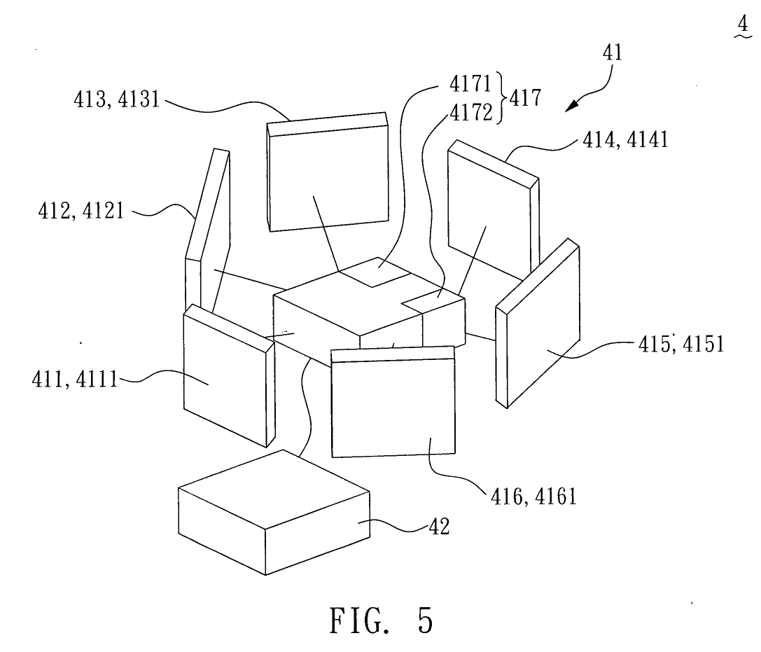

FIG. 5 is a schematic view of the second WiFi base station 4 according to an embodiment of the invention. As shown in FIG. 5, the second WiFi base station 4 includes a second base station interference-free antenna module 41 and a second signal processor 42. The second base station interference-free antenna module 41 has a plurality of second high frequency transceivers 411 to 416 and a second antenna controller 417. The second high frequency transceivers 411 to 416 face different directions respectively. The second antenna controller 417 is electrically coupled to the second high frequency transceivers 411 to 416 respectively. In addition, the second antenna controller 417 is electrically coupled to the second signal processor 42 in order to select one of the second high frequency transceivers 411, 412, 413, 414, 415 and 416 based on a signal transmitting/receiving request output by the second signal processor 42 to thereby transmit or receive a circularly polarized second high frequency signal.

As shown in FIG. 3, one of the first high frequency transceivers 311 to 316 (in this case, the first high frequency transceiver 311) faces the second WiFi base station 4, and one of the second high frequency transceivers 411 to 416 (in this case, the second high frequency transceiver 411) faces the first WiFi base station 3.

In this embodiment, the first base station interference-free antenna module 31 shown in FIG. 4 has six first high frequency transceivers 311 to 316, each being a patch array antenna. Each of the first high frequency transceivers 311 to 316 has a rectangle plate 3111, 3121, 3131, 3141, 3151, 3161, with a size of 10 cm×10 cm. The first antenna controller 317 includes a circular polarization filter portion 3171 to filter the first high frequency signals respectively received by the first high frequency transceivers 311 to 316. Thus, only the first high frequency signal with a specific circular polarization (such as left-hand circular polarization) can be obtained and delivered to the first signal processor 32 of the first WiFi base station 3. In addition, in this embodiment, the first antenna controller 317 includes an electronic scan switch circuit board 3172 to rapidly switch and select one of the first high frequency transceivers 311, 312, 313, 314, 315 and 316 electronically based on a signal transmitting/receiving request output by the first signal processor 32 to thereby transmit or receive a circularly polarized first high frequency signal. In this case, the frequency of the circularly polarized first high frequency signals transmitted or received by the first high frequency transceivers 311, 312, 313, 314, 315 and 316 is about 2.4 GHz (upon the practical needs, the actual frequency is slightly varied in a frequency range between 3.4 GHz and 3.6 GHz or between 5.6 GHz to 5.8 GHz, for example.)

As shown in FIG. 5 again, in this embodiment, the second base station interference-free antenna module 41 has six second high frequency transceivers 411 to 416, each being a waveguide slot array antenna and has a rectangle plate 4111, 4121, 4131, 4141, 4151, 4161 respectively, with a size of 10 cm×10 cm. The second antenna controller 417 includes a circular polarization filter portion 4171 to filter the second high frequency signals respectively received by the second high frequency transceivers 411 to 416. Thus, only a second high frequency signal with a specific circular polarization (such as a left-hand circular polarization) can be delivered to the second signal processor 42 of the second WiFi base station 4.

In addition, in this embodiment, the second antenna controller 417 includes an electronic scan switch circuit board 4172 to rapidly switch and select one of the high frequency transceivers 411, 412, 413, 414, 415 and 416 electronically based on a signal transmitting/receiving request output by the first signal processor 42 to thereby transmit or receive a circularly polarized second high frequency signal. In this embodiment, the frequency of the circularly polarized second high frequency signals transmitted or received by the second high frequency transceivers 411, 412, 413, 414, 415 and 416 is about 2.4 GHz (upon the practical needs, the actual frequency is slightly varied in a frequency range between 3.4 GHz and 3.6 GHz or between 5.6 GHz to 5.8 GHz, for example.)

As shown in FIG. 3, when the first WiFi base station 3 receives a signal to be forwarded to the second WiFi base station 4 through the physical network line 33, it converts the signal into a corresponding circularly polarized first high frequency signal. Next, the first antenna controller 317 of the first WiFi base station 3 selects the first high frequency transceiver 311 facing the second WiFi base station 4 to transmit the first high frequency signal, and the second antenna controller 417 of the second WiFi base station 4 thus selects the second high frequency transceiver 411 facing the first WiFi base station 3 to receive the first high frequency signal.

In addition, when the second WiFi base station 4 wants to deliver a signal output by the client-side electronic device to the remote server 34, the second antenna controller 417 of the second WiFi base station 4 selects the second high frequency transceiver 411 facing the first WiFi base station 3 to transmit a corresponding circularly polarized second high frequency signal. In this case, the first antenna controller 317 of the first WiFi base station 3 thus selects the first high frequency transceiver 311 facing the second WiFi base station 4 to receive the second high frequency signal. Next, the first WiFi base station 3 converts the received second high frequency signal into a circuit signal and forwards the circuit signal to the remote server 34 through the physical network line 33.

It is noted that, depending on the practical needs, the number of first high frequency transceivers of the first base station interference-free antenna module and the number of second high frequency transceivers of the second station interference-free antenna module can be one to six, but not limited to six as cited in this embodiment. In addition, depending on the practical needs, each of the first high frequency transceivers can be a different type of antenna, which is capable of transmitting or receiving a circularly polarized high frequency signal, such as a waveguide slot array antenna or a sector horn antenna, but not limited to the patch array antenna as cited in this embodiment, and all of the first high frequency transceivers do not need to be the same type of antenna.

Similarly, depending on the practical needs, each of the second high frequency transceivers can be a different type of antenna, which is capable of transmitting or receiving a circularly polarized high frequency signal, such as a patch array antenna or a sector horn antenna, not limited to a waveguide slot array antenna as cited in this embodiment, and all the second high frequency transceivers do not need to be the same type of antenna. The frequency of the first and the second high frequency signals can range between 2.3 GHz and 2.5 GHz, between 3.4 GHz and 3.6 GHz or between 5.6 GHz and 5.8 GHz, depending on the practical needs (such as in different environments), not limited to 2.4 GHz as cited in this embodiment.

As stated, the WiFi base station 3 of the WiFi base station mesh network system of the other embodiment of this invention, uses the first frequency transceiver 311 of the first base station interference-free antenna module 31 to transmit the first high frequency signal, which has a circular polarization characteristic (such as left-hand circular polarization). After the first high frequency signal is reflected by an obstacle (such as a building or vehicle), its circular polarization characteristic would be changed (such as from left-hand circular polarization to right-hand circular polarization). At this point, as the circular polarization filter portion 4171 of the second antenna controller 417 of the second WiFi base station 4 limits that only a first high frequency signal with a specific circular polarization (such as a left-hand circular polarization) can pass and be delivered to the second signal processor 42, the first high frequency signals reflected by the obstacle cannot be delivered to the second signal processor 42 of the second WiFi base station 4 even they enter the high frequency transceivers 411 to 416 of the second WiFi base station 4. Accordingly, the noises produced by the reflected first high frequency signals are effectively suppressed, and the SNR of wirelessly transmitting the first high frequency signals is raised.

Since the circular polarization characteristic of the high frequency signals would be changed after the signals are reflected by the obstacle, the circular polarization characteristic can be restored to the original circular polarization (such as the left-hand circular polarization) when the first high frequency signals are reflected again. In this case, even though the circularly polarized first high frequency signals which have been reflected twice is able to pass the circular polarization filter portion 4171 of the antenna controller 417 of the antenna module 41 of the second WiFi base station 4, and be delivered to the signal processor 42, the strength of the first high frequency signals is decayed to a very low level after being reflected twice, and the wireless transmission of the first high frequency signal between two WiFi base stations (in this case, the first and the second WiFi base station 3 and 4) would not be affected by the noises produced by the first high frequency signals which have been reflected twice. Accordingly, the SNR of wirelessly transmitting the first high frequency signals would not be decreased by the first high frequency signals which have been reflected twice, and in the WiFi base station mesh network system, the wireless transmission efficiency of the first high frequency signal between two WiFi base stations (in this case, the first and the second WiFi base station 3 and 4) is raised.

Since the wireless transmission efficiency of the first high frequency signal between two WiFi base stations (in this case, the first and the second WiFi base station 3 and 4) and the SNR of the wireless transmission are raised, the distance between the WiFi base stations in the WiFi base station mesh network system can be increased (i.e., the deployment density of the WiFi base stations is reduced), but the QoS (such as signal stability and signal loss ratio) is maintained at a desired level.

To summarize, the high frequency signals transmitted by the high frequency transceivers of the base station interference-free antenna module have a circular polarization (such as left-hand circular polarization) characteristic, and the circular polarization characteristic would be changed (such as from left-hand circular polarization to right-hand circular polarization) when the high frequency signals are reflected by an obstacle (such as a building or vehicle). Thus, as the circular polarization filtering property of the antenna controller of the base station interference-free antenna module of the other WiFi base station limits that only a high frequency signal with a specific circular polarization (such as left-hand circular polarization) can pass and be delivered to the signal processor, the high frequency signals reflected by the obstacle cannot be delivered to the signal processor of the other WiFi base station because of its right-hand circular polarization, even if they enter the high frequency transceivers of the other WiFi base station. Accordingly, the noises produced by the reflected high frequency signals are effectively suppressed and thereby the SNR of wirelessly transmitting the high frequency signals is raised, and the wireless transmission efficiency of the high frequency signals between two WiFi base stations is also raised.

Similarly, since all of the high frequency transceivers of the antenna module of the WiFi base stations in the WiFi base station mesh network system can transmit or receive a circularly polarized high frequency signal, the other WiFi base station can easily receive the circularly polarized high frequency signal when one of the WiFi base stations transmits the circularly polarized high frequency signal, and the SNR and the transmission efficiency of wirelessly transmitting the high frequency signals are accordingly raised. Thus, the distance between the WiFi base stations in the WiFi base station mesh network system can be increased (i.e., the deployment density of the WiFi base stations can be decreased) while maintaining the QoS at a certain level.

Although the present invention has been explained in relation to its preferred embodiment, it is to be understood that many other possible modifications and variations can be made without departing from the spirit and scope of the invention as hereinafter claimed.

What is claimed is:

1. A base station interference-free antenna module, which is implemented in a wireless fidelity (WiFi) base station with a signal processor, and applied to a high frequency signal transmission between the WiFi base station and a second WiFi base station, the base station interference-free antenna module comprising:
a plurality of high frequency transceivers facing different directions respectively; and
an antenna controller electrically coupled to the high frequency transceivers respectively;
wherein the antenna controller is electrically coupled to the signal processor in order to receive a signal transmitting/receiving request output by the signal processor to select a high frequency transceiver accordingly to transmit or receive a circularly polarized high frequency signal.

2. The base station interference-free antenna module as claimed in claim 1, wherein the number of high frequency transceivers ranges from one to six.

3. The base station interference-free antenna module as claimed in claim 1, wherein each of the high frequency transceivers is a patch array antenna.

4. The base station interference-free antenna module as claimed in claim 1, wherein the antenna controller comprises a circular polarization filter portion to filter the high frequency signal respectively received by the high frequency transceivers.

5. The base station interference-free antenna module as claimed in claim 1, wherein each of the high frequency transceivers comprises a rectangle plate.

6. The base station interference-free antenna module as claimed in claim 1, wherein the antenna controller comprises an electronic scan switch circuit board.

7. The base station interference-free base station antenna module as claimed in claim 1, wherein the frequency of the high frequency signal ranges between 2.3 GHz to 2.5 GHz, between 3.4 GHz to 3.6 GHz or between 5.6 GHz to 5.8 GHz.

8. A WiFi base station mesh network system, comprising:
a first WiFi base station, which includes a first base station interference-free antenna module and a first signal processor, the first base station interference-free antenna module having a plurality of first high frequency transceivers facing different directions and a first antenna controller electrically coupled to the first high frequency transceivers respectively and the first signal processor, in order to select a first high frequency transceiver based on a signal transmitting/receiving request output by the first signal processor to thereby transmit or receive a circularly polarized first high frequency signal; and
a second WiFi base station, which includes a second base station interference-free antenna module and a second signal processor, the second base station interference-free antenna module having a plurality of second high frequency transceivers facing different directions and a second antenna controller electrically coupled to the second high frequency transceivers and the second signal processor, in order to select a second high frequency transceiver based on a signal transmitting/receiving request output by the second signal processor to thereby transmit or receive a circularly polarized second high frequency signal;
wherein one of the first high frequency transceivers faces the second WiFi base station, and one of the second high frequency transceivers faces the first WiFi base station.

9. The WiFi base station mesh network system as claimed in claim 8, wherein the first WiFi base station is electrically coupled to a remote server through a physical network line.

10. The WiFi base station mesh network system as claimed in claim 8, wherein the second antenna controller selects the second high frequency transceiver facing the first WiFi base station to receive the first high frequency signal when the first antenna controller selects the first high frequency transceiver facing the second WiFi base station to transmit the first high frequency signal.

11. The WiFi base station mesh network system as claimed in claim 10, wherein the first antenna controller selects the first high frequency transceiver facing the second WiFi base station to receive the second high frequency signal when the second antenna controller selects the second high frequency transceiver facing the first WiFi base station to transmit the second high frequency signal.

12. The WiFi base station mesh network system as claimed in claim 8, wherein each of the first high frequency transceivers is a patch array antenna, and each of the second high frequency transceivers is a waveguide slot array antenna.

13. The WiFi base station mesh network system as claimed in claim 8, wherein the first antenna controller comprises a first circular polarization filter portion to filter the first high frequency signal respectively received by the first high frequency transceivers, and the second antenna controller comprises a second circular polarization filter portion to filter the second high frequency signal respectively received by the second high frequency transceivers.

14. The WiFi base station mesh network system as claimed in claim 8, wherein the each of the first high frequency transceivers comprises a first rectangle plate, and each of the second high frequency transceivers comprises a second rectangle plate.

15. The WiFi base station mesh network system as claimed in claim 8, wherein each of the first and the second antenna controllers comprises an electronic scan switch circuit board.

16. The WiFi base station mesh network system as claimed in claim 8, wherein the frequency of the first and the second high frequency signals respectively ranges between 2.3 GHz to 2.5 GHz, between 3.4 GHz to 3.6 GHz or between 5.6 GHz to 5.8 GHz.
